(19) United States
(12) Patent Application Publication
(10) Pub. No.: US 2015/0131277 A1
(43) Pub. Date: May 14, 2015

(54) LED TUBE

(71) Applicant: SHENZHEN JIAWEI PHOTOVOLTAIC LIGHTING CO., LTD., SHENZHEN (CN)

(72) Inventors: HUA-ZHENG LI, SHENZHEN (CN); CHUNG-CHI LIU, TAIPEI CITY (TW)

(73) Assignee: SHENZHEN JIAWEI PHOTOVOLTAIC LIGHTING CO., LTD., SHENZHEN (CN)

(21) Appl. No.: 14/078,700

(22) Filed: Nov. 13, 2013

(51) Int. Cl. F21V 29/56; F21V 29/89; F21S 4/00; F21V 29/74; F21K 99/00; F21V 23/00

(52) U.S. Cl. CPC F21V 29/56; F21K 9/175; F21V 23/005; F21S 4/008; F21V 29/74; F21V 29/89; F21Y 2103/003
USPC 362/218

(57) ABSTRACT

An LED tube comprises a glass tube, a PCB disposed in the glass tube, a heat-dissipating colloid disposed in the glass tube, a plurality of LED lights disposed on the PCB, and two electrode caps respectively connected to both ends of the glass tube. By densely filling a room between a peripheral wall of the glass tube and a top surface of the PCB with the heat-dissipating colloid, an exhaust heat caused by illuminating the LED lights and a high temperature generated from the PCB are absorbed and dissipated out of the tube, thereby constructing a connective dissipating concatenation of heat conduction. A heat-disipating unit can be preferably disposed at an exterior periphery of the tube to obtain a quick and multiple heat-dissipating effect and decrease the temperature in the glass tube, thereby facilitating the illuminating efficiency and increasing the duration of the LED tube.

### BACKGROUND OF THE INVENTION

1. Field of the Invention

The present invention relates to a tube, especially to an LED tube which obtains a quick and multiple heat dissipating concatenation and greatly increases the use duration.

2. Description of the Related Art

Referring to FIG. 1, a conventional LED illuminating apparatus 1 comprises a tube 11, a circuit board 12 disposed in the tube 1, a heat-dissipating layer 13 coated on the circuit board 12, a plurality of LED lights 14 (briefly shown) disposed on the circuit board 13, and two electrode caps 15 respectively connected to both ends of the tube 11. The tube 11 is a hollow pattern enclosed by a peripheral wall 111, and a recess 112 is correspondingly formed at the middle of the peripheral wall 111 for an embedment of the circuit board 12, whereby the tube 11 defines a first accommodating room 113 and a second accommodating room 114 relative to the recess 12. The circuit board 12 provides a top surface 121 coated with the heat-dissipating layer 13 and a bottom surface 122 for allowing the LED lights 14 to be pivoted thereon and for generating an electrical connection. In use, the LED lights 14 generate light sources by the circuit board 12 and emanate them out through the tube 11. The exhaust heat caused by the LED lights 14 and the high temperature generated from the circuit board 12 are absorbed by the heat-dissipating layer 13.

However, the circuit board 12 and the LED lights 14 are wrapped in the tube 11, so the exhaust heat generated during the illumination of the LED lights 14 and the high temperature caused by the circuit board 12 while supplying electricity cannot be entirely dispersed and may be accumulated within the rooms 113, 114 of the tube 11. Consequently, only the use of the heat-dissipating layer 13 on the top surface 121 to disperse heat is not enough, and the circuit board 12 is still affected by the exhaust heat and the high temperature directly or indirectly. As a result, the circuit board 12 is easily damaged by the exhaust heat and the high temperature, which does the LED illuminating apparatus 1 a lot of harm.

Consequently, there are other improvements for heat dissipation. As shown in FIG. 2 and FIG. 3, a further conventional LED tube 2 comprises a glass tube 21, a metal heat-dissipating base 22, an LED chip circuit board 23, and two electrode caps 24. The glass tube 21 is a hollow cylinder with characteristics of heat conduction and transparency. Two openings are defined on the tube 21 for allowing the placement of the electrode caps 24. The metal heat-dissipating base 22 is a long curved strip, and an accommodating trench 221 is disposed on the metal heat-dissipating base 22 for accommodating the LED chip circuit board 23. A reverse side of the metal heat-dissipating base 22 is adhered to the inner wall of the glass tube 21 through a heat-conducting gel 25. While using, the heat-conducting gel 25 allows the metal heat-dissipating base 22 and the glass tube 21 to be closely attached together. Therefore, the metal heat-dissipating base 22 does not easily drop off due to the poor adhesion affected by the illumination of the LED chip circuit board 23, thereby radiating the heat to the exterior periphery of the glass tube 21 to maintain the duration of the LED tube 2. Nevertheless, both ends of the glass tube 21 are covered and sealed by the electrode caps 24 and the heat-dissipating base 22 is made of metal materials having the property of collecting heat at the time of contacting heat, so the interior of the glass tube 21 is still in the high temperature situation when the metal heat-dissipating base 22 absorbs heat. The effect of using the heat-conducting gel 25 at the reverse side of the metal heat-dissipating base 22 to dissipate heat out of the tube 21 is still limited. As a result, the LED chip circuit board 23 disposed in the glass tube 21 is still affected and damaged by the high temperature and the exhaust heat, which however shortens the duration of the LED tube 2 and needs to be improved.

### SUMMARY OF THE INVENTION

Accordingly, the purpose of the present invention is to provide an LED tube which uses a heat-dissipating colloid to fill the first accommodating room between the peripheral wall of the glass tube and the top surface of the printed circuit board (PCB). The present invention can further cooperate with a heat-dissipating unit disposed at an exterior periphery of the glass tube, thereby constructing a connective dissipating concatenation of heat conduction for attaining the quick and efficient heat dissipation and greatly increasing the duration of the LED tube.

An LED tube comprises a glass tube, a printed circuit board (PCB), a heat-dissipating colloid, a plurality of LED lights disposed on the circuit board, and two electrode caps respectively connected to both ends of the glass tube. The glass tube is enclosed by a peripheral wall to become hollow. The PCB providing a top surface and a bottom surface is pivotally disposed in the glass tube. The glass tube defines a first accommodating room facing the top surface and a second accommodating room facing the LED lights pivotally disposed on the bottom surface. The heat-dissipating colloid fills the first accommodating room and is placed between the top surface and the peripheral wall. Consequently, by filling the first accommodating room with the heat-dissipating colloid above the top surface of the PCB, the exhaust heat caused by the illumination of the LED lights in the glass tube and the high temperature generated form the PCB while supplying electricity are completely absorbed and dissipated out of the peripheral wall of the glass tube, thereby promoting the heat dissipation. Preferably, with a further arrangement of the heat-dissipating unit, a multiple connective dissipating concatenation of heat conduction can be constructed. Therefore, the high temperature in the glass tube is reduced to facilitate the quick heat dissipation, promote the illuminating efficiency of the LED tube, and prolong the duration of the LED tube greatly.

Preferably, a heat-dissipating unit corresponding to the heat-dissipating colloid is disposed at the exterior periphery of the glass tube.

Preferably, the heat-dissipating colloid provides a plurality of heat-dissipating fins.

Preferably, the heat-dissipating unit is a printed coating layer with metallic materials able to conduct heat.

Preferably, the heat-dissipating unit is an adhesive film containing metallic components.

Preferably, the heat-dissipating unit outwardly extends from the exterior periphery of the glass tube into the interior thereof and connects the top surface of the printed circuit board (PCB). The heat-dissipating colloid fills the first accommodating room.

The advantages of the present invention over the known prior arts are more apparent to those of ordinary skilled in the art upon reading following descriptions in junction with the drawings.

### BRIEF DESCRIPTION OF THE DRAWINGS

FIG. 1 is a schematic view showing components of a conventional LED light 1;

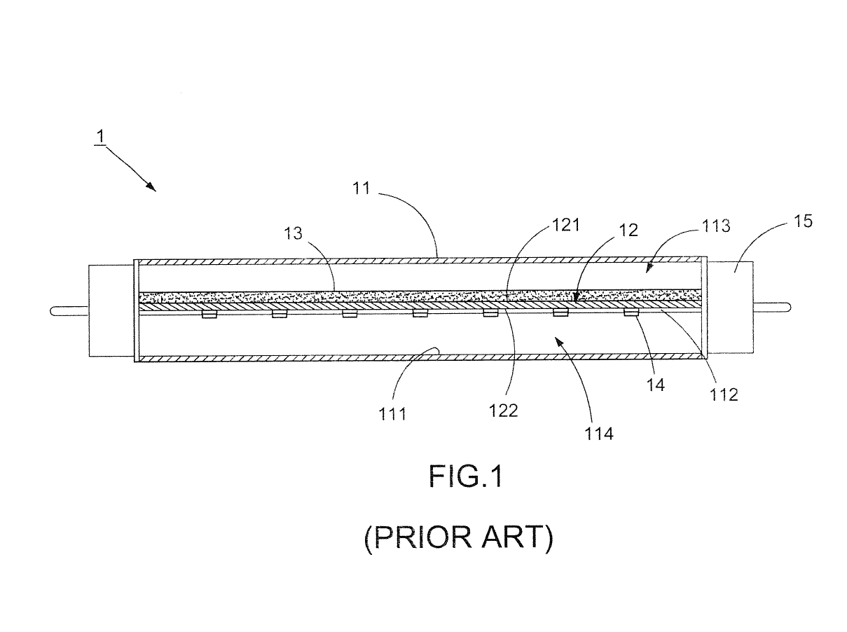

FIG. 2 is a perspective view showing a conventional LED light 2;

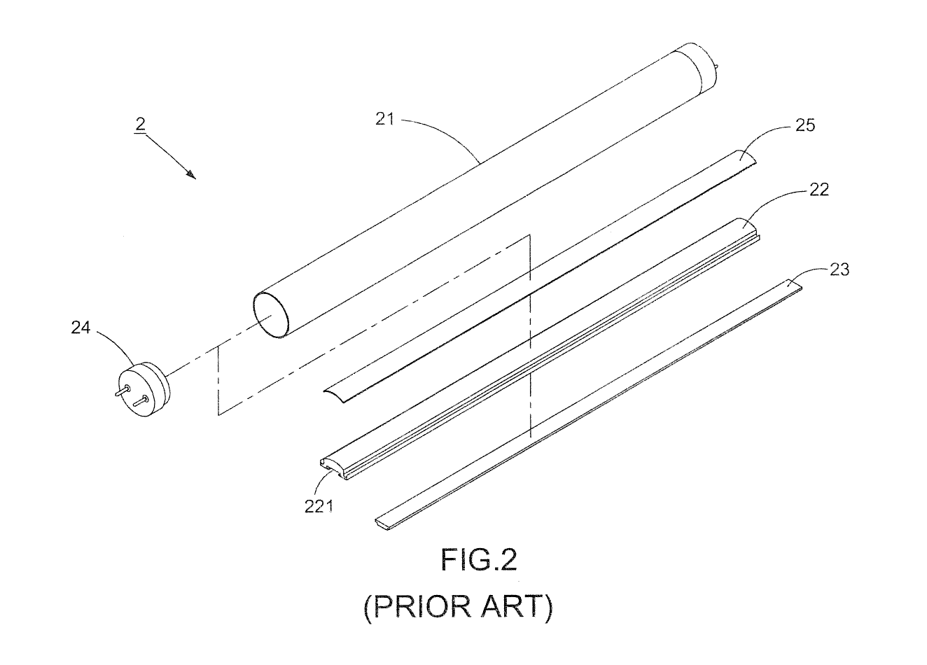

FIG. 3 is a cross-sectional view showing partial components of the conventional invention 2;

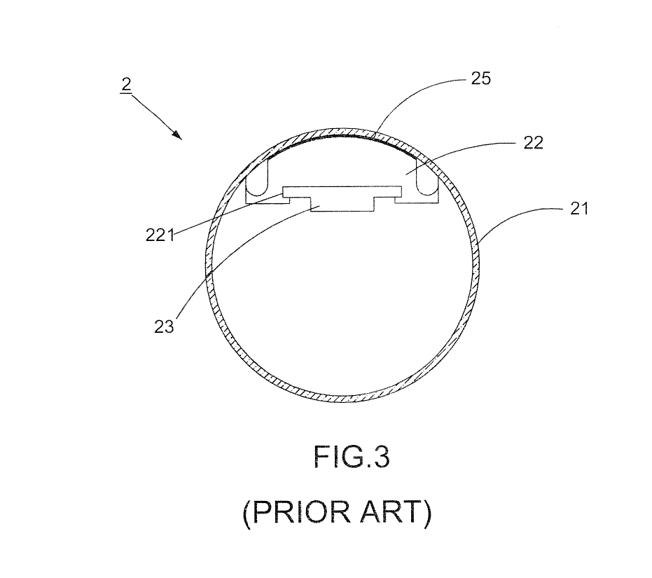

FIG. 4 is a perspective view showing a first preferred embodiment of the present invention;

FIG. 5 is a cross-sectional view showing partial components of this preferred embodiment;

FIG. 6 is a cross-sectional view showing a second preferred embodiment of the present invention; and

FIG. 7 is a schematic view showing a third preferred embodiment of the present invention.

### DETAILED DESCRIPTION OF THE PREFERRED EMBODIMENTS

Before the present invention is described in greater detail, it should be noted that the like elements are denoted by the same reference numerals throughout the disclosure.

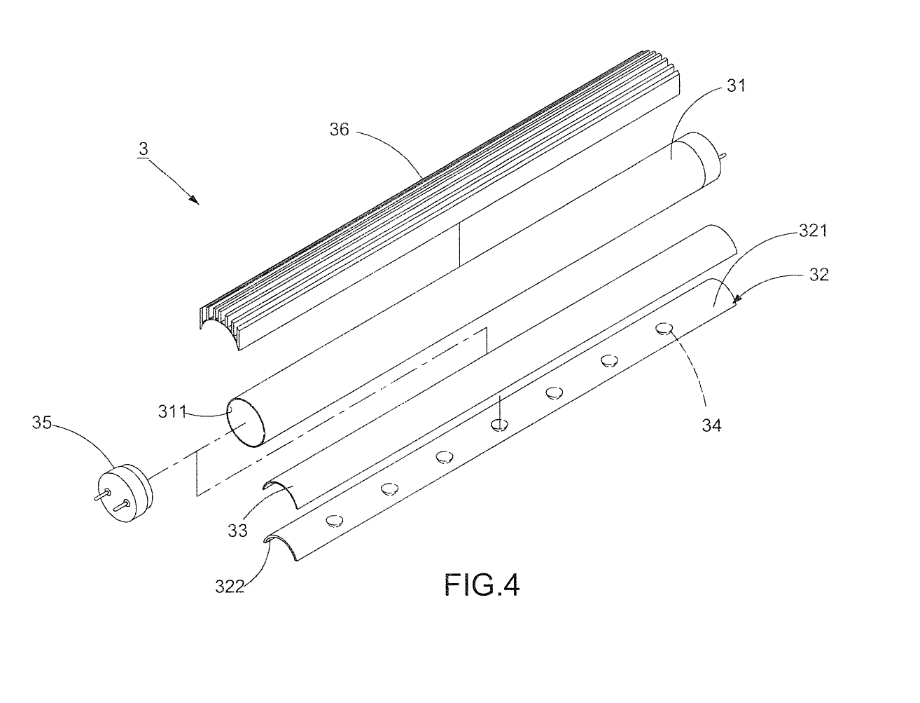

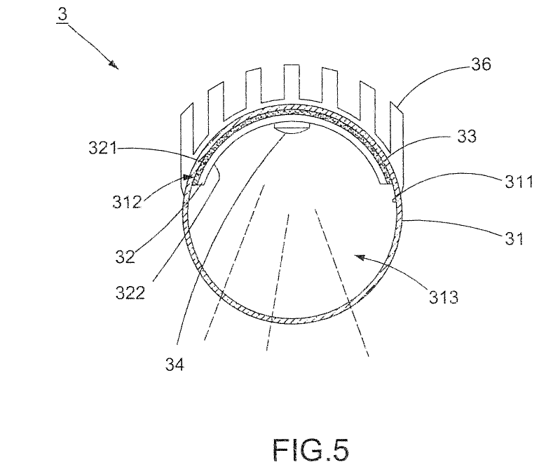

Referring to FIG. 4, the first preferred embodiment of the present invention comprises a glass tube 31, a printed circuit board (PCB) 32 disposed in the glass tube 31, a heat-dissipating colloid 33 disposed in the glass tube 31, a plurality of LED lights 34 disposed on the PCB 32, and, two electrode caps 35 respectively connected to both ends of the glass tube 31. The PCB 32 is a soft circuit board and it provides a top surface 321 and a bottom surface 322 which allows the LED lights 34 to be pivoted thereon for generating an electrical connection. Also referring to FIG. 5, the glass tube 31 is a hollow pattern enclosed by a peripheral wall 311, and the PCB 32 providing a top surface 321 and a bottom surface 322 is pivotally disposed on the tube 31. The glass tube 31 defines a first accommodating room 312 facing the top surface 321 and a second accommodating room facing the LED lights 34 disposed on the bottom surface 322. The first accommodating room 312 is filled with the heat-dissipating colloid 33 above the top surface 321 for forming a dense attachment between the PCB 32 and the glass tube 31. As shown in dotted lines, the LED lights 34 disposed on the bottom surface 322 emanate the light from the second accommodating room 313 through the glass tube 31.

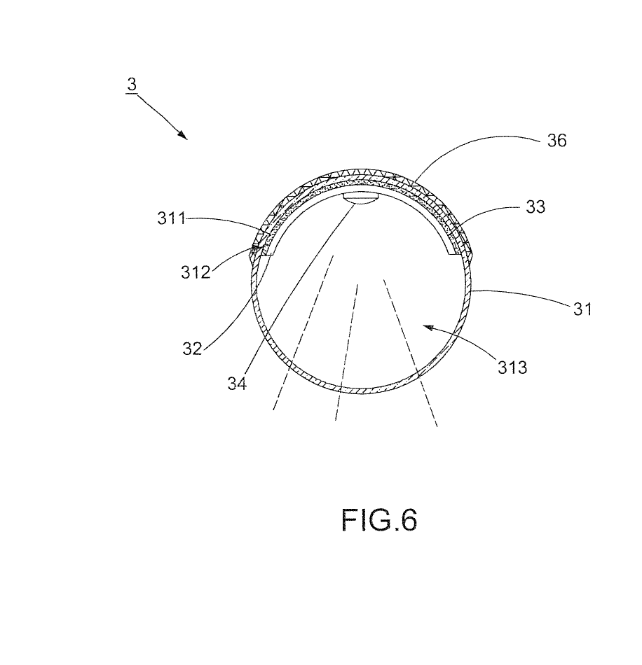

In this embodiment, a heat-dissipating unit 36 corresponding to the heat-dissipating colloid 33 is disposed at the exterior periphery of the glass tube 31. The heat-dissipating unit 36 can have a plurality of heat-dissipating fins. Alternatively, as briefly shown in FIG. 6, the heat-dissipating unit 36 can be a printed coating layer with metallic materials able to conduct heat or be an adhesive film containing metallic components. The printed coating layer can be a material containing heat-conducting materials, such as graphite powder, aluminum powder, glass powder, and heat-dissipating materials, and can be coated at the exterior periphery of the glass tube 31 by printing or spraying. The adhesive film, which adopts a metal adhesive film like a film sticker containing aluminum, is attached to the exterior periphery of the glass tube 31 for totally absorbing and dispersing the heat which is conducted to the glass tube 31 by the heat-dissipating colloid 33. Consequently, the heat-dissipating colloid 33, the peripheral wall 311 and the heat-dissipating unit are combined to form a multiple connective dissipating concatenation.

As shown in FIG. 4 and FIG. 5, during the installation, the soft property of the PCB 32 allows the PCB 32 to be pivotally disposed in the glass tube 31 according to the shape of the tube 31 By completely filling the first accommodating room 312 with the heat-dissipating colloid 33, a dense attachment between the PCB 32 and the peripheral wall 311 of the glass tube 31 is obtained. In use, the PCB 32 is electrified via the electrode caps 35 sealing both ends of the glass tube 31 to generate electricity. Subsequently, the LED lights 34 on the PCB 32 are electrically connected to illuminate. The illumination of the LED lights 34 generates the exhaust heat in the glass tube 31, and the high temperature is generated at the time of supplying electricity via the PCB 32. By means of the heat-dissipating colloid 33, the heat and the high temperature are absorbed entirely, radiated by the peripheral wall 311, and thence dispersed out of the heat-dissipating unit 36 quickly. The dissipating colloid 33, the PCB 32, and the peripheral wall 311 are directly connected together to construct a dissipating concatenation of heat conduction. The arrangement of the heat-dissipating unit 36 at the exterior periphery of the glass tube 31 allows the LED tube 3 to become a multiple dissipating concatenation of heat conduction, which increases the heat-dissipating area and reduces the temperature in the glass tube 31. Therefore, the preferable heat-dissipating effect is obtained, the illuminating efficiency of the LED lights 34 is promoted, and the duration of the LED tube 3 is increased.

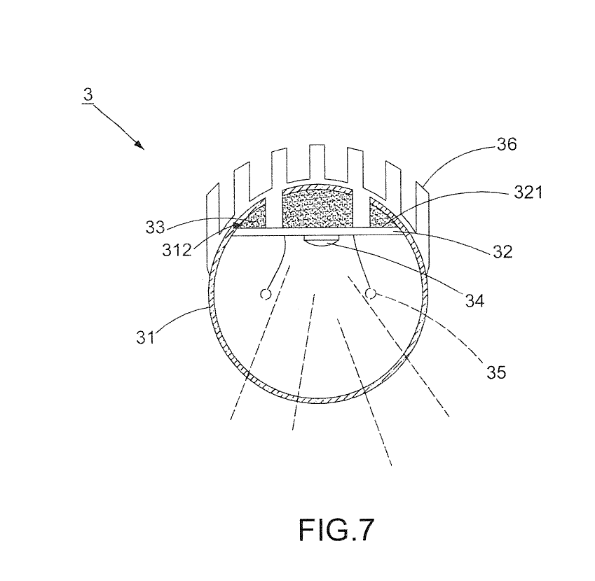

Referring to FIG. 7, a third preferred embodiment of the present invention still comprises the same components as the previous embodiment. This embodiment includes a glass tube 31, a PCB 32, a heat-dissipating colloid 33, LED lights 34, electrode caps 35, and a heat-dissipating unit 36. In particular, the heat-dissipating unit 36 outwardly extends from the exterior periphery of the glass tube 31 into the interior thereof and connects the top surface 321 of the PCB 32, which obtains a more obvious heat-dissipating effect of the LED tube 3 when the heat-dissipating colloid 33 still fills the first accommodating room 312. Consequently, by the heat-dissipating unit 36 extending into the interior of the glass tube 31 and connecting the PCB 32, the heat in the glass tube 31 is outwardly dissipated, and the heat-dissipating effect is doubled. As a result, the PCB 32 disposed in the glass tube 31 keeps the normal status of the use, and the duration of the LED tube 3 is improved greatly.

To sum up, the present invention takes advantage of filling the first accommodating room of the glass tube with a heat-dissipating colloid above the top surface of the PCB to generate a dense attachment between the PCB and the peripheral wall of the glass tube without interstices. The heat-dissipating unit can be preferably disposed at the exterior periphery of the glass tube to form a multiple heat-dissipating concatenation of heat conduction, thereby attaining the quick and efficient heat dissipation for reducing the temperature in the glass tube. Therefore, the illuminating efficiency is promoted, and the duration of the LED tube is greatly prolonged.

While we have shown and described the embodiment in accordance with the present invention, it should be clear to those skilled in the art that further embodiments may be made without departing from the scope of the present invention.

What is claimed is:

1. An LED tube comprising a glass tube, a printed circuit board (PCB) disposed in said glass tube, a heat-dissipating colloid disposed in said glass tube, a plurality of LED lights disposed on said printed circuit board, and two electrode caps respectively connected to both ends of said glass tube; wherein said printed circuit board (PCB) provides a top surface and a bottom surface pivotally connected with said LED lights for generating an electrical connection; said glass tube being enclosed by a peripheral wall to become hollow; said printed circuit board (PCB) being pivotally disposed in said glass tube, and said glass tube defining a first accommodating room facing said top surface and a second accommodating room facing said LED lights disposed on said bottom surface; said heat-dissipating colloid filling said first accommodating room and being placed between said top surface and said peripheral wall, whereby said printed circuit board (PCB), said heat-dissipating colloid, and said peripheral wall are combined to form a connection of heat conduction.

2. The LED tube as claimed in claim 1, a heat-dissipating unit corresponding to said heat-dissipating colloid is disposed at an exterior periphery of said glass tube.

3. The LED tube as claimed in claim 2, wherein said heat-dissipating colloid provides a plurality of heat-dissipating fins.

4. The LED tube as claimed in claim 2, wherein said heat-dissipating unit is a printed coating layer with metallic materials able to conduct heat.

5. The LED tube as claimed in claim 2, wherein said heat-dissipating unit is an adhesive film containing metallic components.

6. The LED tube as claimed in claim 3, wherein said heat-dissipating unit outwardly extends from an exterior periphery of said glass tube into an interior thereof and connects said top surface of said printed circuit board (PCB); said heat-dissipating colloid filling said first accommodating room.
